(19) United States
(12) Patent Application Publication
(10) Pub. No.: US 2025/0197647 A1
(43) Pub. Date: Jun. 19, 2025

(54) WEATHER RESISTANT PANEL

(71) Applicant: BASF SE, Ludwigshafen am Rhein (DE)

(72) Inventors: Shuk-Kwan Jackie MURPHY, Birmingham, AL (US); Luke S. Egan, Rock Hill, SC (US)

(73) Assignee: BASF SE, Ludwigshafen am Rhein (DE)

(21) Appl. No.: 18/945,780

(22) Filed: Nov. 13, 2024

Related U.S. Application Data
(60) Provisional application No. 63/610,430, filed on Dec. 15, 2023.

(51) Int. Cl. C09D 5/08; C08K 3/22; C08K 3/34; C09D 5/14; C09D 133/20; E04B 1/64

(52) U.S. Cl. CPC C09D 5/084; C09D 5/14; C09D 133/20; E04B 1/64; C08K 3/22; C08K 2003/2241; C08K 3/346

(57) ABSTRACT

A weather resistant panel pre-coated with a polymer barrier coating having air permeability, water vapor-permeability, and self-healing nail-scalability. Methods for preparing the weather resistant panel are also disclosed.

### CROSS-REFERENCE TO RELATED APPLICATIONS

This application claims the benefit of priority from U.S. Provisional Patent Application No. 63/610,430, filed Dec. 15, 2023, the disclosure of which is incorporated herein by reference.

### FIELD OF THE INVENTION

The present invention relates to a weather resistant panel (board) pre-coated with a polymer barrier coating having air permeability, water vapor-permeability, and self-healing nail-scalability and a method for preparing a weather resistant panel system.

### BACKGROUND OF THE INVENTION

In the construction industry, which includes residential and commercial buildings, the architecture of a building may have an emotional impact on a person or community. The architecture of the building not only improves the aesthetics of the building from outside but also improves the comfort of the people living inside. An important aspect of a building's architecture is the building material, which is an integral part of the building and is used for attaining the type and form of the building's structure. However, performance of building materials is affected by micro-climatic conditions such as weather, decay, waterlogging, etc. Construction materials like wooden boards and oriented strand boards (OSB) cannot withstand prolonged exposure to water, moisture, variable temperatures and high winds. Thus, the building materials need to withstand unintended passage of air, water, moisture, heat and other elements.

To alleviate these problems, construction industry has introduced barrier wraps, coatings, and/or coated panels (weather resistant panels/barriers) as part of the building envelop system. However, during installations of these systems at the construction sites, many of these barriers are perforated due to obligatory introduction of fasteners such as nails, screws, staples, etc. These perforations, nail holes, joints, and other penetrations expose these panels/barriers to unwanted air, water, moisture, heat and other elements. Additionally, leakage of air, water, moisture or heat through these perforations adversely affects the comfort of occupants and reduces energy efficiency during heating or cooling of the building. It is desired for a building's design to prevent water seepage into inner structures of the building, leakage of water vapor into or out of the building, and unwarranted air movement into or out of the building.

Therefore, there is a need for continued development of weather resistant panels i.e., panels with a weather resistant coating, which are “nail sealable”, “breathable” i.e. air permeable, “vapor permeable” and resistant to water, heat and other unwanted elements.

Thus, it is an object of the presently claimed invention to provide a weather resistant coating that functions as a “semi-permeable air barrier” or “breathable barrier” or “medium permeable vapor retarder” according to International Residential Code (IRC), Class III.

It is another object of the presently claimed invention to provide a weather resistant coating that functions as a “vapor permeable barrier” according to ASTM E96.

It is yet another object of the presently claimed invention to provide a weather resistant coating that functions as a “self-healing nail sealable barrier” according to ASTM D1970.

It is still another object of the presently claimed invention to provide a weather resistant coating that is characterized for water absorption according to ASTM D471.

It is still another object of the presently claimed invention to provide a weather resistant coating that is free of organic solvent.

It is still another object of the presently claimed invention to provide a weather resistant coating with low Volatile Organic Compounds (VOC).

It is still another object of the presently claimed invention to provide a coated weather resistant panel having a coating that can be cured with and/or without ultraviolet (UV) rays/electron beam (EB).

It is still another object of the presently claimed invention to fabricate at a manufacturing site a panel with a weather resistant coating, which has acceptable blocking resistance, which is easy to transport to the construction site and that helps improve the case of installation of weather resistant panels during construction.

It is still another object of the presently claimed invention to provide weather resistant coating that is environmentally friendly.

### SUMMARY OF THE INVENTION

Surprisingly, it has been found that a panel with a weather resistant coating, which functions as a “nail scalable”, “breathable” or “vapor permeable” barrier, is obtained by providing at least one panel comprising at least one surface, on which a first coating composition comprising 34.0 wt. % to 75.0 wt. % of at least one first aqueous acrylate-acrylonitrile copolymer dispersion having a first pigment volume concentration (PVC) from 8% to 20% and a second coating composition comprising 20.0 wt. % to 60.0 wt. % of at least one second aqueous acrylate-acrylonitrile copolymer dispersion having a second pigment volume concentration (PVC) from 20% to 52% are applied, such that the first coating is adjacent to the at least one surface of the at least one panel, and the second coating is adjacent to the first coating and the combination of the first coating and the second coating forms a weather resistant coating on the at least one panel, which is characterized by:
i) medium permeable vapor retarding properties according to International Residential Code (IRC), Class III;
ii) self-healing nail scalability, according to ASTM D1970;
iii) water absorption from 0 to 10 according to ASTM D471; and
iv) water vapour transmission rate from 0.1 to 10.0 perms as determined according to ASTM E96.

Thus, in a first aspect, the presently claimed invention is directed to a panel with a weather resistant coating obtained by:
a) providing at least one panel comprising at least one surface;
b) providing a first coating composition comprising,
   i) 34.0 wt. % to 75.0 wt. % of at least one first aqueous acrylate-acrylonitrile copolymer dispersion;
   ii) 0.5 wt. % to 9.0 wt. % of at least one first pigment;
   iii) 3.0 wt. % to 20.0 wt. % of at least one first filler, at least one first extender, and combinations thereof; and
   iv) 0.1 wt. % to 10.0 wt. % of at least one first additive;
wherein the weight percent being relative to the total weight of the first coating composition;
and wherein the first coating composition has a first pigment volume concentration (PVC) from 8% to 20%;
c) applying 50.0 g/m² to 275.0 g/m² of the first coating composition on the at least one surface of the at least one panel;
d) drying the first coating composition on the at least one surface of the at least one panel to obtain a first coating;
e) providing a second coating composition comprising,
   i) 20.0 wt. % to 60.0 wt. % of at least one second aqueous acrylate-acrylonitrile copolymer dispersion;
   ii) 1.0 wt. % to 7.0 wt. % of at least one second pigment; and
   iii) 5.0 wt. % to 25.0 wt. % of at least one second filler and at least one second extender, and combinations thereof; and
   iv) 0.1 wt. % to 10.0 wt. % of at least one second additive;
wherein the weight percent being relative to the total weight of the second coating composition;
and wherein the second coating composition has a second pigment volume concentration (PVC) from 20% to 52%;
f) applying 50.0 g/m² to 275.0 g/m² of the second coating composition on the dried first coating; and
g) drying the second coating composition on the dried first coating to obtain a second coating, wherein the first coating being adjacent to the at least one surface of the at least one panel, and the second coating being adjacent to the first coating; wherein the combination of the first coating and the second coating forms a weather resistant coating on the at least one panel; and
wherein the weather resistant coating being characterized by:
   i) medium permeable vapor retarding properties according to International Residential Code (IRC), Class III;
   ii) self-healing nail scalability, according to ASTM D1970;
   iii) water absorption from 0 to 10 according to ASTM D471; and
   iv) water vapour transmission rate from 0.1 to 10.0 perms as determined according to ASTM E96.

Second aspect of the presently claimed invention is directed to a method for preparing a weather resistant panel system, the method comprising:
a) providing at least two weather resistant panels according to an embodiment of first aspect;
b) positioning the at least two weather resistant panels adjacently into a desired position against a structure; and
c) fastening the adjacently positioned weather resistant panels against the structure to obtain the weather resistant panel system.

### DETAILED DESCRIPTION

Before the method of the presently claimed invention is described, it is to be understood that this invention is not limited to particular method described, since such method may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc, and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc, relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

The presently claimed invention provides a weather resistant panel, which functions as a “nail scalable”, “breathable” or “vapor permeable” barrier, obtained by providing at least one panel comprising at least one surface, on which a first coating composition comprising 34.0 wt. % to 75.0 wt. % of at least one first aqueous acrylate-acrylonitrile copolymer dispersion having a first pigment volume concentration (PVC) from 8% to 20% and a second coating composition comprising 20.0 wt. % to 60.0 wt. % of at least one second aqueous acrylate-acrylonitrile copolymer dispersion having a second pigment volume concentration (PVC) from 20% to 52% are applied such that the first coating is adjacent to the at least one surface of the at least one panel, and the second coating is adjacent to the first coating and the combination of the first coating and the second coating forms a weather resistant coating on the at least one panel.

In a first aspect, the presently claimed invention is directed to a weather resistant panel obtained by:
a) providing at least one panel comprising at least one surface;
b) providing a first coating composition comprising,
   i) 34.0 wt. % to 75.0 wt. % of at least one first aqueous acrylate-acrylonitrile copolymer dispersion;
   ii) 0.5 wt. % to 9.0 wt. % of at least one first pigment;
   iii) 3.0 wt. % to 20.0 wt. % of at least one first filler, at least one first extender, and combinations thereof; and
   iv) 0.1 wt. % to 10.0 wt. % of at least one first additive;
wherein the weight percent being relative to the total weight of the first coating composition; and wherein the first coating composition has a first pigment volume concentration (PVC) from 8% to 20%;
c) applying 50.0 g/m² to 275.0 g/m² of the first coating composition on the at least one surface of the at least one panel;
d) drying the first coating composition on the at least one surface of the at least one panel to obtain a first coating;
e) providing a second coating composition comprising,
   i) 20.0 wt. % to 60.0 wt. % of at least one second aqueous acrylate-acrylonitrile copolymer dispersion;
   ii) 1.0 wt. % to 7.0 wt. % of at least one second pigment; and
   iii) 5.0 wt. % to 25.0 wt. % of at least one second filler and at least one second extender, and combinations thereof; and
   iv) 0.1 wt. % to 10.0 wt. % of at least one second additive;
wherein the weight percent being relative to the total weight of the second coating composition;
and wherein the second coating composition has a second pigment volume concentration (PVC) from 20% to 52%;
f) applying 50.0 g/m² to 275.0 g/m² of the second coating composition on the dried first coating; and
g) drying the second coating composition on the dried first coating to obtain a second coating, wherein the first coating being adjacent to the at least one surface of the at least one panel, and the second coating being adjacent to the first coating;
wherein the combination of the first coating and the second coating forms a weather resistant coating on the at least one panel; and
wherein the weather resistant coating being characterized by:
   i) medium permeable vapor retarding properties according to International Residential Code (IRC), Class III;
   ii) self-healing nail sealability, according to ASTM D1970;
   iii) water absorption from 0 to 10 according to ASTM D471; and
   iv) water vapour transmission rate from 0.1 to 10.0 perms as determined according to ASTM E96.

According to the present invention one of the key composition variables to control the ultimate performance of the weather resistant coating with respect to “nail sealable”, “breathable” i.e. air permeable or “vapor permeable” barrier, is “Pigment Volume Concentration” of topcoat and basecoat.

The first coating composition (basecoat) has a lower PVC with respect to the topcoat composition and provides more elastomeric flexibility for the nail sealability tests.

The at least one panel may be any type of building panel such as a furniture component, a floor panel, a ceiling panel, a wall panel, a door panel, a worktop, skirting boards, mouldings, edging profiles, etc.

In a preferred embodiment, the at least one panel is selected from wooden panel, gypsum board, plywood, sheathing panel, oriented strand board (OSB), drywall panels or combinations thereof.

More preferably, the at least one panel is selected from wooden panel, gypsum board, plywood, oriented strand board (OSB), or combinations thereof.

The present invention uses a moisture resistant eXP exterior panel (board) used as basestock, eXP® Sheathing consists of a moisture- and mold-resistant gypsum core encased in a coated, specially designed PURPLE fiberglass mat on the face, back and sides. The glass mat is folded around the long edges to reinforce and protect the core.

The present invention uses acrylic latex and resins with or without radical functional groups for basecoat coating compositions.

In a preferred embodiment, in the step of providing a first coating composition, the at least one first acrylate-acrylonitrile copolymer comprises at least one first acrylate and at least one first acrylonitrile. The first acrylate-acrylonitrile copolymer comprises the first acrylate from 90.0 wt. % to 99.95 wt. %, and the first acrylonitrile from 0.05 wt. % to 10.0 wt. %.

In a preferred embodiment, in the step of providing a first coating composition, the at least one first acrylate is selected from methyl acrylate, ethyl acrylate, n-butyl acrylate, iso-butyl acrylate, t-butyl acrylate, isoamyl acrylate, 2-ethylhexyl acrylate, n-hexyl acrylate, n-heptyl acrylate, 2-methylheptyl acrylate, octyl acrylate, isooctyl acrylate, n-nonyl acrylate, isononyl acrylate, n-decyl acrylate, isodecyl acrylate, dodecyl acrylate, lauryl acrylate, tridecyl acrylate, stearyl acrylate, isobornyl acrylate, ureido acrylate, glycidyl acrylate, hydroxyethyl acrylate, allyl acrylate, tetrahydrofurfuryl acrylate, cyclohexyl acrylate, 2-ethoxyethyl acrylate, 2-methoxy acrylate, 2-(2-ethoxyethoxy)ethyl acrylate, 2-propylheptyl acrylate, 2-phenoxyethyl acrylate, isobornyl acrylate, caprolactone acrylate, polypropyleneglycol monoacrylate, polyethyleneglycol acrylate, benzyl acrylate, hydroxypropyl acrylate, methylpolyglycol acrylate, 3,4-epoxycyclohexylmethyl acrylate, 1,6 hexanediol diacrylate, 1,4 butanediol diacrylate, trimethylolpropane triacrylate, pentaerythritol tetraacrylate, methyl (meth)acrylate, ethyl (meth)acrylate, n-butyl (meth)acrylate, iso-butyl (meth)acrylate, t-butyl (meth)acrylate, isoamyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, isobornyl methacrylate, ureido methacrylate, glycidyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy(meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate, methacrylic acid, methyl (meth)acrylic acid, acrylamide or combinations thereof, and the at least one first acrylonitrile being selected from acrylonitrile, (meth)acrylonitrile or combinations thereof.

More preferably, in the step of providing a first coating composition, the at least one first acrylate is selected from n-butyl acrylate, methyl (meth)acrylate, methyl (meth)acrylate, 2-ethylhexyl acrylate, and acrylamide and the at least one first acrylonitrile being selected from acrylonitrile, (meth)acrylonitrile or combinations thereof.

In a preferred embodiment, in the step of providing a first coating composition, the at least one first acrylate comprises 45.0 wt. % to 90.0 wt. % n-butyl acrylate, 1.0 wt. % to 3.0 wt. % methyl (meth)acrylate, 0.0 wt. % to 35.0 wt. % methyl (meth)acrylate, 0.0 wt. % to 20.0 wt. % 2-ethylhexyl acrylate, 0.5 wt. % to 3.0 wt. % acrylamide and the at least one first acrylonitrile comprises 0.05 wt. % to 10.0 wt. % acrylonitrile.

The present invention utilizes coating compositions (basecoat and topcoat) comprising less than 100% solids. The present invention uses very little or almost no organic solvent. In the present invention acrylic latex and resins are dispersed in aqueous solvent, such as water. As water is an environmentally friendly solvent, the present invention for preparing a weather resistant panels is environmentally friendly.

In a preferred embodiment, in the step of providing a first coating composition, at least one first aqueous acrylate-acrylonitrile copolymer dispersion comprises from 30 to 75% solids.

In another preferred embodiment, in the step of providing a first coating composition, at least one first aqueous acrylate-acrylonitrile copolymer dispersion comprises from 38 to 67% solids.

In a preferred embodiment, in the step of providing a first coating composition, the at least one first aqueous acrylate-acrylonitrile copolymer dispersion has a glass transition temperature from −25° C., to −35° C.

In another preferred embodiment, in the step of providing a first coating composition, the at least one first aqueous acrylate-acrylonitrile copolymer dispersion has a glass transition temperature from −10° C., to −35° C.

Preferably, in the step of providing a first coating composition, the at least one first aqueous acrylate-acrylonitrile copolymer dispersion having a glass transition temperature from 0° C., to −35° C.

In a preferred embodiment, in the step of providing a first coating composition, the at least one first pigment is selected from rutile titanium dioxide (TiO₂), Carbon Black, Micronized precipitated silica, Talc, and combinations thereof.

Preferably, in the step of providing a first coating composition, the at least one first pigment is rutile titanium dioxide (TiO₂).

In a preferred embodiment, in the step of providing a first coating composition, the at least one first filler is selected from sodium-potassium alumina silicate (silica deficient), zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof, and wherein the at least one first extender being selected from sodium-potassium alumina silicate (silica deficient), zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof.

Preferably, in the step of providing a first coating composition, the at least one first filler is selected from sodium-potassium alumina silicate (silica deficient), zinc oxide, and combinations thereof.

More preferably, in the step of providing a first coating composition, the at least one first filler is sodium-potassium alumina silicate (silica deficient).

In a preferred embodiment, in the step of providing a first coating composition, the at least one first additive is starch, as a first drying agent.

In another preferred embodiment, in the step of providing a first coating composition, the at least one first additive is a first photoinitiator selected from benzophenone, alpha hydroxy ketone, acryl phosphone oxide and combinations thereof.

Preferably, in the step of providing a first coating composition, the at least one first additive is benzophenone, a first photoinitiator.

Viscosity was measured using ASTM method D562 on a Brookfield KU-2 viscometer in Krebs Unit (KU). Additionally, for ease of reference, the corresponding values in centipoise (cps) have also been provided herein at suitable places on-basis of the conversion tables available in the instrument operating manual. In a preferred embodiment, in the step of providing a first coating composition, the first coating composition having a viscosity from 75 KU (or 750 cps) to 128 KU (or 3558 cps) determined using a Brookfield KU-2 Viscometer as described by ASTM method D562.

Preferably, in the step of providing a first coating composition, the first coating composition having a viscosity from 80 KU (or 806 cps) to 125 KU (or 3312 cps) determined using a Brookfield KU-2 Viscometer as described by ASTM method D562.

More preferably, in the step of providing a first coating composition, the first coating composition having a viscosity from 85 KU (or 956 cps) to 120 KU (or 2850 cps) determined using a Brookfield KU-2 Viscometer as described by ASTM method D562.

Viscosity in such ranges provides desired coating and application properties of the basecoat (first coating composition).

In the present invention during the step of applying a first coating composition, the panel's initial temperature can vary but should not be lower than 15° C.

In a preferred embodiment, the step of applying a first coating composition involves applying the first coating composition over a time period from 10 to 60 seconds at a temperature from 15° C., to 87° C.

In a preferred embodiment, the step of applying a first coating composition involves applying 75.0 g/m² to 225.0 g/m² of the first coating composition on the at least one surface of the at least one panel.

In another preferred embodiment, the step of applying a first coating composition involves applying 100.0 g/m² to 200.0 g/m² of the first coating composition on the at least one surface of the at least one panel.

In a preferred embodiment, the step of applying a first coating composition involves applying the first coating composition at a temperature from 15° C., to 70° C.

In a preferred embodiment, the step of applying a first coating composition involves applying the first coating composition over a time period from 15 to 50 seconds.

The first coating composition of the present invention, having a glass transition temperature (T_{g}) in the range of −25° C., to 30° C., has a suitable viscosity for applying the first coating on the surface of a panel. The first coating composition is suitable for application by using any standard coating machinery such as roller coating, curtain coating, spraying, etc. The first coating composition is suitable for application at standard application temperatures and does not need special equipment. On applying the first coating composition, desirable wetting and adherence to the surface is achieved.

In a preferred embodiment, in the step of drying a first coating composition, the first coating is capable of undergoing curing by irradiation using energy rays.

In the step of drying a first coating composition, the panel's final temperature should be at least 87° C.

In a preferred embodiment, the step of drying a first coating composition involves drying the first coating composition applied on the at least one surface of the at least one panel, over a time period from 10 to 60 seconds at a temperature from 87° C., to 235° C.

In a preferred embodiment, the step of drying a first coating composition, involves (i) drying the first coating composition applied on the at least one surface of the at least one panel, over a time period from 10 to 60 seconds at a temperature from 87° C., to 235° C., and (ii) subjecting the dried first coating composition on the at least one surface of the at least one panel, over a time period from 5 to 60 seconds using energy rays from 0.8 mJ/gsm to 1.5 mJ/gsm.

The coating compositions of the present invention comprising less than 100% solids require ovens to speed the drying process. For drying coating compositions that comprise less than 100% solids, oven exposure in a temperature range of 65-285° C., is useful to speed the drying of compositions. The temperature range of 65-285° C., is used for drying a broader range of coating compositions.

The present invention uses environmentally friendly solvents in basecoat coating compositions, such as water.

The basecoat (first coating composition) is an aqueous composition and is dried under heating as it helps to drive the water from the coating more rapidly. Thus, the first coating is free of organic solvent, has low volatile organic compounds (VOC), and is environmentally friendly.

The acrylic latex and resin-based basecoat compositions of the present invention can be cured with and without Ultraviolet/Electron Beam.

The first coating composition may be cured prior to applying the second coating composition. The first coating may be cured by heat and/or by radiation. The first coating composition may be cured by a heating device using infrared (IR), near-infrared (NIR), hot air, etc., to form a first coating. The first coating composition comprising a UV curing agent may be cured by a radiation such as ultraviolet (UV), electron beam (EB) rays, etc., to form a first coating.

In a preferred embodiment, the first coating composition further comprising at least one first defoamer, first rheology modifier, first dispersing agent and combinations thereof.

In a preferred embodiment, in the step of providing a first coating composition, the first coating composition comprising at least one first defoamer, first rheology modifier, first dispersing agent and combinations thereof.

Preferably, in the step of providing a first coating composition, the at least one first defoamer is selected from silicone, mineral oil, vegetable oil, white oil and combinations thereof.

More preferably, in the step of providing a first coating composition, the at least one first defoamer is selected from silicone, mineral oil, and combinations thereof.

Preferably, in the step of providing a first coating composition, the at least one first rheology modifier is selected from water-soluble Methyl cellulose, Hydroxy ethyl cellulose (HEC), Carboxy methyl cellulose (CMC), Methyl hydroxyethyl celluloses (MHEC), Hydroxy propyl cellulose (HPC), Hydrophobically modified hydroxyethyl cellulose (HMEC), and combinations thereof.

More preferably, in the step of providing a first coating composition, the at least one first rheology modifier is selected from water-soluble hydroxy ethyl cellulose (HEC).

Preferably, in the step of providing a first coating composition, the at least one first dispersing agent is selected from polyacrylic acid or derivatives thereof. More preferably the first dispersing agent is selected from ammonium polyacrylate polymer, sodium polyacrylate, carboxylic acid copolymer, and combinations thereof.

The present invention uses acrylic latex and resins with or without radical functional groups for topcoat coating compositions.

The second coating composition (topcoat) may have a higher PVC with respect to the basecoat composition and provides more mechanical strength (blocking resistance).

In a preferred embodiment, in the step of providing a second coating composition, the at least one second aqueous acrylate-acrylonitrile copolymer comprises at least one second acrylate and at least one second acrylonitrile, and the second acrylate-acrylonitrile copolymer comprises the second acrylate from 90.0 wt. % to 99.5 wt. %, and the second acrylonitrile from 0.05 wt. % to 10 wt. %.

In a preferred embodiment, in the step of providing a second coating composition, the at least one second acrylate is selected from methyl acrylate, ethyl acrylate, n-butyl acrylate, iso-butyl acrylate, t-butyl acrylate, isoamyl acrylate, 2-ethylhexyl acrylate, n-hexyl acrylate, n-heptyl acrylate, 2-methylheptyl acrylate, octyl acrylate, isooctyl acrylate, n-nonyl acrylate, isononyl acrylate, n-decyl acrylate, isodecyl acrylate, dodecyl acrylate, lauryl acrylate, tridecyl acrylate, stearyl acrylate, isobornyl acrylate, ureido acrylate, glycidyl acrylate, hydroxyethyl acrylate, allyl acrylate, tetrahydrofurfuryl acrylate, cyclohexyl acrylate, 2-ethoxyethyl acrylate, 2-methoxy acrylate, 2-(2-ethoxyethoxy)ethyl acrylate, 2-propylheptyl acrylate, 2-phenoxyethyl acrylate, isobornyl acrylate, caprolactone acrylate, polypropyleneglycol monoacrylate, polyethyleneglycol acrylate, benzyl acrylate, hydroxypropyl acrylate, methylpolyglycol acrylate, 3,4-epoxycyclohexylmethyl acrylate, 1,6 hexanediol diacrylate, 1,4 butanediol diacrylate, trimethylolpropane triacrylate, pentaerythritol tetraacrylate, methyl (meth)acrylate, ethyl (meth)acrylate, n-butyl (meth)acrylate, iso-butyl (meth)acrylate, t-butyl (meth)acrylate, isoamyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, isobornyl methacrylate, ureido methacrylate, glycidyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy(meth)acrylate, 2-(2-ethoxyethoxy) ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri (meth)acrylate, pentaerythritol tetra(meth)acrylate, methacrylic acid, methyl (meth)acrylic acid, acrylamide or combinations thereof, and the at least one second acrylonitrile is selected from acrylonitrile, (meth)acrylonitrile or combinations thereof.

More preferably, in the step of providing a second coating composition, the at least one first acrylate being selected from n-butyl acrylate, methyl (meth)acrylate, methyl (meth)acrylate, 2-ethylhexyl acrylate, and acrylamide and the at least one first acrylonitrile being selected from acrylonitrile, (meth)acrylonitrile or combinations thereof.

In a preferred embodiment, in the step of providing a second coating composition, the at least one first acrylate being 45.0 wt. % to 90.0 wt. % n-butyl acrylate. 1.0 wt. % to 3.0 wt. % methyl (meth)acrylate, 0.0 wt. % to 35.0 wt. % methyl (meth)acrylate, 0.0 wt. % to 20.0 wt. % 2-ethylhexyl acrylate, 0.5 wt. % to 3.0 wt. % acrylamide and the at least one first acrylonitrile being 0.05 wt. % to 10.0 wt. % acrylonitrile.

In a preferred embodiment, in the step of providing a second coating composition, the at least one second aqueous acrylate-acrylonitrile copolymer dispersion comprising from 30 to 75% solids.

In a preferred embodiment, in the step of providing a second coating composition, the at least one second aqueous acrylate-acrylonitrile copolymer dispersion comprising from 38% to 67% solids.

In a preferred embodiment, in the step of providing a second coating composition, the at least one second aqueous acrylate-acrylonitrile copolymer dispersion having a glass transition temperature from −25° C., to −35° C.

In another preferred embodiment, in the step of providing a second coating composition, the at least one second aqueous acrylate-acrylonitrile copolymer dispersion having a glass transition temperature from −10° C., to −35° C.

Preferably, in the step of providing a second coating composition, the at least one second aqueous acrylate-acrylonitrile copolymer dispersion having a glass transition temperature from 0° C. to −35° C.

In a preferred embodiment, in the step of providing a second coating composition, the at least one second pigment being selected from rutile titanium dioxide (TiO₂), Carbon Black, Micronized precipitated silica, Talc, and combinations thereof.

Preferably, in the step of providing a second coating composition, the at least one second pigment is rutile titanium dioxide (TiO₂).

In a preferred embodiment, in the step of providing a second coating composition, the at least one second filler being selected from sodium-potassium alumina silicate (silica deficient), zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof, and wherein the at least one second extender being selected from sodium-potassium alumina silicate (silica deficient), zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof.

Preferably, in the step of providing a second coating composition, the at least one second filler being selected from sodium-potassium alumina silicate (silica deficient), zinc oxide, and combinations thereof.

More preferably, in the step of providing a second coating composition, the at least one second filler is sodium-potassium alumina silicate (silica deficient).

In a preferred embodiment, in the step of providing a second coating composition, the at least one second additive is starch, a drying agent.

In a preferred embodiment, in the step of providing a second coating composition, the at least one second additive being a second photoinitiator selected from benzophenone, alpha hydroxy ketone, acryl phosphone oxide and combinations thereof.

Preferably, in the step of providing a second coating composition, the at least one second additive is benzophenone, a second photoinitiator.

In a preferred embodiment, in the step of providing a second coating composition, involves the second coating composition having a viscosity from 70 KU (or 560 cps) to 120 KU (or 2854 cps) determined using a Brookfield KU-2 Viscometer as described by ASTM method D562.

Preferably, in the step of providing a second coating composition, involves the second coating composition having a viscosity from 75 KU (or 681 cps) to 115 KU (or 2515 cps) determined using a Brookfield KU-2 Viscometer as described by ASTM method D562.

More preferably, in the step of providing a second coating composition, involves the second coating composition having a viscosity from 80 KU (or 806 cps) to 110 KU (or 2205 cps) determined using a Brookfield KU-2 Viscometer as described by ASTM method D562.

Viscosity in such ranges provides desired coating and application properties of the topcoat (second coating composition).

In the present invention during the step of applying a first coating composition, the panel's initial temperature can vary but should not be lower than 15° C.

In a preferred embodiment, the step of applying a second coating composition involves applying the second coating composition over a time period from 10 to 60 seconds at a temperature from 15° C., to 87° C.

In a preferred embodiment, the step of applying a second coating composition involves applying 75.0 g/m² to 225.0 g/m² of the second coating composition on the at least one surface of the at least one panel.

In another preferred embodiment, the step of applying a second coating composition involves applying 100.0 g/m² to 200.0 g/m² of the second coating composition on the at least one surface of the at least one panel.

In a preferred embodiment, the step of applying a second coating composition involves applying the second coating composition at a temperature from 15° C., to 70° C.

In a preferred embodiment, the step of applying a second coating composition involves applying the second coating composition over a time period from 15 to 50 seconds.

The second coating composition having a glass transition temperature (T_{g}) in the range of −25° C., to 30° C., has a suitable viscosity for applying the second coating on the surface of the first coating for forming a second coating. The second coating composition is suitable for application by using any standard coating machinery such as roller coating, curtain coating, spraying, etc. The second coating composition is suitable for application at standard application temperatures and does not need special equipment. On applying the second coating composition, desirable wetting and adherence to the surface of the first coating is achieved.

In a preferred embodiment, in the step of providing a second coating composition, the second coating composition is capable of undergoing irradiation using energy rays.

A second coating composition may be applied on the surface of the first coating for forming a second coating. In some embodiments the second coating composition is applied on at least a portion of the surface of the first coating. Preferably, the second coating composition is applied on substantially the complete surface of the first coating, such that the second coating covers the complete surface of the first coating. Preferably, the first coating and the second coating adhere to each other.

In a preferred embodiment, in the step of drying a second coating composition, the second coating composition is capable of undergoing curing by irradiation using energy rays.

In the step of drying a second coating composition, the panel's final temperature may be at least 87° C.

In a preferred embodiment, the step of drying a second coating composition involves drying the second coating composition applied on the at least one surface of the at least one first coating, over a time period from 10 to 60 seconds at a temperature from 87° C., to 235° C.

In a preferred embodiment, the step of drying a second coating composition, involves (i) drying the second coating composition applied on the at least one surface of the at least one first coating, over a time period from 10 to 60 seconds at a temperature from 87° C., to 235° C., and (ii) subjecting the dried second coating composition on the at least one surface of the at least one first coating, over a time period from 5 to 60 seconds using energy rays from 0.8 mJ/gsm to 1.5 mJ/gsm.

The coating compositions of the present invention comprising less than 100% solids require ovens to speed the drying process. For drying coating compositions that comprise less than 100% solids, oven exposure in a temperature range of 65-285° C., is useful to speed the drying of compositions. The temperature range of 65-285° C., is used for drying a broader range of coating compositions.

The present invention uses environmentally friendly solvent in topcoat coating compositions, such as water.

The topcoat (second coating composition) is an aqueous composition and is dried under heating as it helps to drive the water from the coating more rapidly. Thus, the second coating is free of organic solvent, has low volatile organic compounds (VOC), and is environmentally friendly.

The acrylic latex and resin-based topcoat compositions of the present invention can be cured with and without Ultraviolet/Electron Beam.

After applying the second coating composition on the surface of the first coating, it is cured by heat and/or by radiation. The second coating composition is cured by a heating device using infrared (IR), near-infrared (NIR), hot air, etc., to form a second coating. The second coating composition comprising a UV curing agent is cured by a radiation such as ultraviolet (UV), electron beam (EB) rays, etc., to form a second coating.

In a preferred embodiment, the second coating composition further comprises at least one first defoamer, first rheology modifier, first dispersing agent and combinations thereof.

The first coating and second coating may be translucent or transparent after drying and/or curing. The first and/or second coating may partially or completely stain the surface of the panel with a desirable colour.

In the final product i.e. weather resistant panel, it may be difficult to see any distinction between the first coating and the second coating. There may be a zone between the first and second coating wherein the first and second coating are fused together.

In a preferred embodiment, in the step of providing a second coating composition, the second coating composition comprises at least one first defoamer, first rheology modifier, first dispersing agent and combinations thereof.

Preferably, in the step of providing a second coating composition, the at least one second defoamer is selected from silicone, mineral oil, vegetable oil, white oil and combinations thereof.

More preferably, in the step of providing a second coating composition, the at least one second defoamer is selected from silicone, mineral oil, and combinations thereof.

Preferably, in the step of providing a second coating composition, the at least one second rheology modifier is selected from water-soluble methyl cellulose, hydroxy ethyl cellulose (HEC), carboxy methyl cellulose (CMC), methyl hydroxyethyl celluloses (MHEC), hydroxy propyl cellulose (HPC), hydrophobically modified hydroxyethyl cellulose (HMEC), and combinations thereof.

More preferably, in the step of providing a second coating composition, the at least one second rheology modifier is selected from water-soluble hydroxy ethyl cellulose (HEC).

Preferably, in the step of providing a second coating composition, the at least one second dispersing agent is selected from polyacrylic acid or derivatives thereof. More preferably the second dispersing agent is selected from ammonium polyacrylate polymer, sodium polyacrylate, carboxylic acid copolymer, and combinations thereof.

After applying the second coating composition, one or more additional coating compositions may be applied on the second coating for forming additional coatings.

The weather resistant panel further comprises at least one second defoamer, second rheology modifier, second dispersing agent and combinations thereof.

The weather resistant panel as described herein, wherein the first coating being adjacent to the at least one surface of the at least one panel, and the second coating being adjacent to the first coating; and wherein the combination of the first coating and the second coating forms a weather resistant coating on the at least one panel; and wherein the weather resistant coating being characterized by:
i) medium permeable vapor retarding properties according to International Residential Code (IRC), Class III;
ii) self-healing nail sealability, according to ASTM D1970;
iii) water absorption from 0 to 10, preferably 0.1 to 7, more preferably 0.5 to 5 according to ASTM D471; and
iv) water vapour transmission rate from 0.1 to 10.0, preferably 0.1 to 7, more preferably 0.5 to 5 perms as determined according to ASTM E96.

In a second aspect, the presently claimed invention is directed to a method for preparing a weather resistant panel system, the method comprises:
a) providing at least two coated weather resistant panels according to first aspect;
b) positioning the at least two weather resistant panels adjacently into a desired position against a structure; and
c) fastening the adjacently positioned weather resistant panels against the structure to obtain the weather resistant panel system:

In a preferred embodiment, in the step of providing at least two weather resistant panels, the at least two weather resistant panels are prefabricated at a production site, wherein the at least two weather resistant panels are aligned at a building site, and wherein the production site and the building site are independent of each other.

In a preferred embodiment, in the step of positioning at least two weather resistant panels adjacently, the structure is selected from a wall, a roof, a plain surface, and combinations thereof.

In a preferred embodiment, the step of fastening involves piercing at least one fastener through the weather resistant panel to secure the panels into a place.

In a preferred embodiment, in the step of fastening, the at least one fastener being selected from nails, staples, screws, and combinations thereof.

In a preferred embodiment, in the step of fastening, the edges between the adjacent weather resistant panels are joined using a tape, a coating, or combination thereof.

### Advantages

The present disclosure is associated with at least one of the following advantages:
Weather resistant coating that functions as a “semi-permeable air barrier” or “breathable barrier” or “medium permeable vapor retarding” according to International Residential Code (IRC), Class III.
Weather resistant coating that functions as a “Vapor permeable barrier” according to ASTM E96.
Weather resistant coating that functions as a “Self-healing nail sealabile barrier” according to ASTM D1970.
System of panels coated with a weather resistant coating that utilizes acrylic latexes and UV/EB curable materials.
A panel with a weather resistant coating that is free of solvent, has low VOC, and can be cured with and/or without UV/EB curable.
Panels with weather resistant coating and suitable blocking resistance, which are prefabricated at a manufacturing site and installed at a construction site.
Weather resistant coating that is environmentally friendly.
Prefabricated weather resistant panels, which significantly improve the ease of installation during constructions.

The intended use of the panels of the present disclosure is air and weather barrier coating, to generate an integrated wall board system, comprising OSB, plywood, gypsum board exterior sheathing materials.

### EMBODIMENTS

In the following, there is provided a list of embodiments to further illustrate the present disclosure without intending to limit the disclosure to the specific embodiments listed below.

1. A weather resistant panel obtained by:
a) providing at least one panel comprising at least one surface;
b) providing a first coating composition comprising,
   i) 34.0 wt. % to 75.0 wt. % of at least one first aqueous acrylate-acrylonitrile copolymer dispersion;
   ii) 0.5 wt. % to 9.0 wt. % of at least one first pigment;
   iii) 3.0 wt. % to 20.0 wt. % of at least one first filler, at least one first extender, and combinations thereof; and
   iv) 0.1 wt. % to 10.0 wt. % of at least one first additive;
   wherein the weight percent being relative to the total weight of the first coating composition; and
   wherein the first coating composition has a first pigment volume concentration (PVC) from 8% to 20%;
c) applying 50.0 g/m² to 275.0 g/m² of the first coating composition on the at least one surface of the at least one panel;
d) drying the first coating composition on the at least one surface of the at least one panel to obtain a first coating;
e) providing a second coating composition comprising,
   i) 20.0 wt. % to 60.0 wt. % of at least one second aqueous acrylate-acrylonitrile copolymer dispersion;
   ii) 1.0 wt. % to 7.0 wt. % of at least one second pigment; and
   iii) 5.0 wt. % to 25.0 wt. % of at least one second filler and at least one second extender, and combinations thereof; and
   iv) 0.1 wt. % to 10.0 wt. % of at least one second additive;
   wherein the weight percent being relative to the total weight of the second coating composition; and
   wherein the second coating composition has a second pigment volume concentration (PVC) from 20% to 52%:
f) applying 50.0 g/m² to 275.0 g/m² of the second coating composition on the dried first coating; and
g) drying the second coating composition on the dried first coating to obtain a second coating, wherein the first coating being adjacent to the at least one surface of the at least one panel, and the second coating being adjacent to the first coating;
   wherein the combination of the first coating and the second coating forms a weather resistant coating on the at least one panel; and
   wherein the weather resistant coating being characterized by:
   v) medium permeable vapor retarding properties according to International Residential Code (IRC), Class III;
   vi) self-healing nail sealability, according to ASTM D1970;
   vii) water absorption from 0 to 10 according to ASTM D471; and
   viii) water vapour transmission rate from 0.1 to 10.0 perms as determined according to ASTM E96.

2. The weather resistant panel according to embodiment 1, wherein in step (a), the at least one panel being selected from wooden panel, gypsum board, plywood, sheathing panel, oriented strand board (OSB), drywall panels or combinations thereof.

3. The weather resistant panel according to any one of embodiments 1 to 2, wherein in step (b), the at least one first aqueous acrylate-acrylonitrile copolymer comprising at least one first acrylate and at least one first acrylonitrile: wherein the first acrylate-acrylonitrile copolymer comprising the first acrylate from 90.0 wt. % to 99.95 wt. %, and the first acrylonitrile from 0.05 wt. % to 10.0 wt. %.

4. The weather resistant panel according to any one of embodiments 1 to 3, wherein in step (b), the at least one first acrylate being selected from methyl acrylate, ethyl acrylate, n-butyl acrylate, iso-butyl acrylate, t-butyl acrylate, isoamyl acrylate, 2-ethylhexyl acrylate, n-hexyl acrylate, n-heptyl acrylate, 2-methylheptyl acrylate, octyl acrylate, isooctyl acrylate, n-nonyl acrylate, isononyl acrylate, n-decyl acrylate, isodecyl acrylate, dodecyl acrylate, lauryl acrylate, tridecyl acrylate, stearyl acrylate, isobornyl acrylate, ureido acrylate, glycidyl acrylate, hydroxyethyl acrylate, allyl acrylate, tetrahydrofurfuryl acrylate, cyclohexyl acrylate, 2-ethoxyethyl acrylate, 2-methoxy acrylate, 2-(2-ethoxyethoxy)ethyl acrylate, 2-propylheptyl acrylate, 2-phenoxyethyl acrylate, isobornyl acrylate, caprolactone acrylate, polypropyleneglycol monoacrylate, polyethyleneglycol acrylate, benzyl acrylate, hydroxypropyl acrylate, methylpolyglycol acrylate, 3,4-epoxycyclohexylmethyl acrylate, 1,6 hexanediol diacrylate, 1,4 butanediol diacrylate, trimethylolpropane triacrylate, pentaerythritol tetraacrylate, methyl (meth)acrylate, ethyl (meth)acrylate, n-butyl (meth)acrylate, iso-butyl (meth)acrylate, t-butyl (meth)acrylate, isoamyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, isobornyl methacrylate, ureido methacrylate, glycidyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy(meth)acrylate, 2-(2-ethoxyethoxy) ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri (meth)acrylate, pentaerythritol tetra(meth)acrylate, methacrylic acid, methyl (meth)acrylic acid, acrylamide or combinations thereof, and the at least one first acrylonitrile being selected from acrylonitrile, (meth)acrylonitrile or combinations thereof.

5. The weather resistant panel according to any one of embodiments 1 to 4, wherein in step (b), the at least one first acrylate being selected from n-butyl acrylate, methyl (meth)acrylate, methyl (meth)acrylate, 2-ethylhexyl acrylate, and acrylamide and the at least one first acrylonitrile being selected from acrylonitrile, (meth)acrylonitrile or combinations thereof.

6. The weather resistant panel according to any one of embodiments 1 to 5, wherein in step (b), the at least one first acrylate being 45.0 wt. % to 90.0 wt. % n-butyl acrylate. 1.0 wt. % to 3.0 wt. % methyl (meth)acrylate, 0.0 wt. % to 35.0 wt. % methyl (meth)acrylate, 0.0 wt. % to 20.0 wt. % 2-ethylhexyl acrylate. 0.5 wt. % to 3.0 wt. % acrylamide and the at least one first acrylonitrile being 0.05 wt. % to 10.0 wt. % acrylonitrile.

7 The weather resistant panel according to any one of embodiments 1 to 6, wherein in step (b), at least one first aqueous acrylate-acrylonitrile copolymer dispersion comprising from 30 to 75% solids.

8. The weather resistant panel according to any one of embodiments 1 to 7, wherein in step (b), at least one first aqueous acrylate-acrylonitrile copolymer dispersion comprising from 38 to 67% solids, preferably from.

9 The weather resistant panel according to any one of embodiments 1 to 8, wherein in step (b), the at least one first aqueous acrylate-acrylonitrile copolymer dispersion having a glass transition temperature from −25° C., to −35° C.

10. The weather resistant panel according to any one of embodiments 1 to 9, wherein in step (b), the at least one first aqueous acrylate-acrylonitrile copolymer dispersion having a glass transition temperature from −10° C., to −35° C.

11. The weather resistant panel according to any one of embodiments 1 to 10, wherein in step (b), the at least one first pigment being selected from rutile titanium dioxide (TiO₂), Carbon Black, Micronized precipitated silica, Talc and combinations thereof.

12. The weather resistant panel according to any one of embodiments 1 to 11, wherein in step (b), the at least one first filler being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof, and wherein the at least one first extender being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof.

13. The weather resistant panel according to any one of embodiments 1 to 12, wherein in step (b), the at least one first additive being a first drying agent is starch.

14. The weather resistant panel according to any one of embodiments 1 to 13, wherein in step (b), the at least one first additive being a first photoinitiator selected from benzophenone, alpha hydroxy ketone, acryl phosphone oxide and combinations thereof.

15. The weather resistant panel according to any one of embodiment 1 to 15, wherein in step (b), the first coating composition having a viscosity from 75 KU (or 681 cps) to 128 KU (or 3558 cps) determined using a Brookfield KU-2 Viscometer as described by ASTM method D562.

16. The weather resistant panel according to any one of embodiments 1 to 15, wherein step (c) involves applying the first coating composition over a time period from 10 to 60 seconds at a temperature from 15° C., to 87° C.

17. The weather resistant panel according to any one of embodiments 1 to 16, wherein step (c) involves applying 75.0 g/m² to 225.0 g/m² of the first coating composition on the at least one surface of the at least one panel.

18. The weather resistant panel according to any one of embodiments 1 to 17 wherein step (c) involves applying 100.0 g/m² to 200.0 g/m² of the first coating composition on the at least one surface of the at least one panel.

19. The weather resistant panel according to any one of embodiments 1 to 18, wherein step (c) involves applying the first coating composition at a temperature from 15° C., to 70° C.

20. The method according to any one of embodiments 1 to 19, wherein step (c) involves applying the first coating composition over a time period from 15 to 50 seconds.

21. The weather resistant panel according to any one of embodiments 1 to 20, wherein in step (d), the first coating being capable of undergoing irradiation using energy rays.

22. The weather resistant panel according to any one of embodiments 1 to 21, wherein step (d) involves drying the first coating composition applied on the at least one surface of the at least one panel, over a time period from 10 to 60 seconds at a temperature from 87° C., to 235° C.

23. The weather resistant panel according to any one of embodiments 1 to 22, wherein step (d) involves:
i) drying the first coating composition applied on the at least one surface of the at least one panel, over a time period from 10 to 60 seconds at a temperature from 87° C. to 235° C., and
ii) subjecting the dried first coating composition on the at least one surface of the at least one panel, over a time period from 5 to 60 seconds using energy rays from 0.8 mJ/gsm to 1.5 mJ/gsm.

24. The weather resistant panel according to any one of embodiments 1 to 23, wherein the first coating composition further comprising at least one first defoamer, first rheology modifier, first dispersing agent and combinations thereof.

25. The weather resistant panel according to any one of embodiments 1 to 24, wherein in step (c), the at least one second acrylate-acrylonitrile copolymer comprising at least one second acrylate and at least one second acrylonitrile: wherein the second acrylate-acrylonitrile copolymer comprising the second acrylate from 90.0 wt. % to 99.5 wt. %, and the second acrylonitrile from 0.05 wt. % to 10 wt. %.

26. The weather resistant panel according to any one of embodiments 1 to 25, wherein in step (c), the at least one second acrylate being selected from methyl acrylate, ethyl acrylate, n-butyl acrylate, iso-butyl acrylate, t-butyl acrylate, isoamyl acrylate, 2-ethylhexyl acrylate, n-hexyl acrylate, n-heptyl acrylate, 2-methylheptyl acrylate, octyl acrylate, isooctyl acrylate, n-nonyl acrylate, isononyl acrylate, n-decyl acrylate, isodecyl acrylate, dodecyl acrylate, lauryl acrylate, tridecyl acrylate, stearyl acrylate, isobornyl acrylate, ureido acrylate, glycidyl acrylate, hydroxyethyl acrylate, allyl acrylate, tetrahydrofurfuryl acrylate, cyclohexyl acrylate, 2-ethoxyethyl acrylate, 2-methoxy acrylate, 2-(2-ethoxyethoxy)ethyl acrylate, 2-propylheptyl acrylate, 2-phenoxyethyl acrylate, isobornyl acrylate, caprolactone acrylate, polypropyleneglycol monoacrylate, polyethyleneglycol acrylate, benzyl acrylate, hydroxypropyl acrylate, methylpolyglycol acrylate, 3,4-epoxycyclohexylmethyl acrylate, 1,6 hexanediol diacrylate, 1,4 butanediol diacrylate, trimethylolpropane triacrylate, pentaerythritol tetraacrylate, methyl (meth)acrylate, ethyl (meth)acrylate, n-butyl (meth)acrylate, iso-butyl (meth)acrylate, t-butyl (meth)acrylate, isoamyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, isobornyl methacrylate, ureido methacrylate, glycidyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy(meth)acrylate, 2-(2-ethoxyethoxy) ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri (meth)acrylate, pentaerythritol tetra(meth)acrylate, methacrylic acid, methyl (meth)acrylic acid, acrylamide or combinations thereof, and the at least one second acrylonitrile being selected from acrylonitrile, (meth)acrylonitrile or combinations thereof.

27. The weather resistant panel according to any one of embodiments 1 to 26, wherein in step (b), the at least one first acrylate being selected from n-butyl acrylate, methyl (meth)acrylate, methyl (meth)acrylate, 2-ethylhexyl acrylate, and acrylamide and the at least one first acrylonitrile being selected from acrylonitrile, (meth)acrylonitrile or combinations thereof.

28. The weather resistant panel according to any one of claims 1 to 27, wherein in step (b), the at least one first acrylate being 45.0 wt. % to 90.0 wt. % n-butyl acrylate, 1.0 wt. % to 3.0 wt. % methyl (meth)acrylate, 0.0 wt. % to 35.0 wt. % methyl (meth)acrylate, 0.0 wt. % to 20.0 wt. % 2-ethylhexyl acrylate, 0.5 wt. % to 3.0 wt. % acrylamide and the at least one first acrylonitrile being 0.05 wt. % to 10.0 wt. % acrylonitrile.

29. The weather resistant panel according to any one of embodiments 1 to 28, wherein in step (e), the at least one second aqueous acrylate-acrylonitrile copolymer dispersion comprising from 30 to 75% solids.

30. The weather resistant panel according to any one of embodiments 1 to 29, wherein in step (c), the at least one second aqueous acrylate-acrylonitrile copolymer dispersion comprising from 38% to 67% solids.

31. The weather resistant panel according to any one of embodiments 1 to 30, wherein in step (e), the at least one second aqueous acrylate-acrylonitrile copolymer dispersion having a glass transition temperature from −25° C., to −35° C.

32. The weather resistant panel according to any one of embodiments 1 to 31, wherein in step (e), the at least one second aqueous acrylate-acrylonitrile copolymer dispersion having a glass transition temperature from −10° C., to −35° C.

33. The weather resistant panel according to any one of embodiments 1 to 32, wherein in step (e), the at least one second pigment being selected from rutile titanium dioxide (TiO₂), Carbon Black, Micronized precipitated silica, Talc, and combinations thereof.

34. The weather resistant panel according to any one of embodiments 1 to 33, wherein in step (e), the at least one second filler being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof, and wherein the at least one second extender being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof.

35. The weather resistant panel according to any one of embodiments 1 to 34, wherein in step (e), the at least one second additive being a second drying agent is starch.

36. The weather resistant panel according to any one of embodiments 1 to 35, wherein in step (e), the at least one second additive being a second photoinitiator selected from benzophenone, alpha hydroxy ketone, acryl phosphone oxide and combinations thereof.

37. The weather resistant panel according to any one of embodiments 1 to 36, wherein step (e) involves the second coating composition having a viscosity from 90 KU (or 1138 cps) to 120 KU (or 2805 cps) determined using a Brookfield KU-2 Viscometer as described by ASTM method D562.

38. The weather resistant panel according to any one of embodiments 1 to 37, wherein step (f) involves applying the second coating composition over a time period from 15 to 60 seconds at a temperature from 18° C. to 120° C.

39. The weather resistant panel according to any one of embodiments 1 to 38, wherein step (f) involves applying 100.0 g/m² to 225.0 g/m² of the second coating composition on the at least one surface of the at least one panel.

40. The weather resistant panel according to any one of embodiments 1 to 39, wherein step (f) involves applying 125.0 g/m² to 200.0 g/m² of the second coating composition on the at least one surface of the at least one panel.

41. The weather resistant panel according to any one of embodiments 1 to 40, wherein step (f) involves applying the second coating composition at a temperature from 50° C. to 105° C., preferably from 70° C. to 102° C.

42. The weather resistant panel according to any one of embodiments 1 to 41, wherein step (f) involves applying the second coating composition over a time period from 25 to 50 seconds.

43. The weather resistant panel according to any one of embodiments 1 to 42, wherein the second coating being capable of undergoing irradiation using energy rays.

44. The weather resistant panel according to any one of claims 1 to 43, wherein step (g) involves drying the second coating composition applied on the at least one surface of the first coating on the at least one panel, over a time period from 10 to 60 seconds at a temperature from 87° C. to 235° C.

45. The weather resistant panel according to any one of claims 1 to 44, wherein step (g) involves:
i) drying the second coating composition applied on the at least one surface of the first coating on the at least one panel, over a time period from 10 to 60 seconds at a temperature from 87° C. to 235° C., and
ii) subjecting the dried second coating composition on the at least one surface of the first coating on the at least one panel, over a time period from 5 to 60 seconds using energy rays from 0.8 mJ/gsm to 1.5 mJ/gsm.

46. The weather resistant panel according to any one of embodiments 1 to 45, further comprising at least one second defoamer, second rheology modifier, second dispersing agent and combinations thereof.

47. A method for preparing a weather resistant panel system, the method comprising:
a) providing at least two weather resistant panels according to embodiment 1;
b) positioning the at least two weather resistant panels adjacently into a desired position against a structure; and
c) fastening the adjacently positioned weather resistant panels against the structure to obtain the weather resistant panel system.

48. The method according to embodiment 47, wherein the at least two weather resistant panels are prefabricated at a production site, wherein the at least two weather resistant panels are aligned at a building site, and wherein the production site and the building site are independent of each other.

49. The method according to any one of embodiments 47 to 48, wherein the structure being selected from a wall, a roof, a plain surface, and combinations thereof.

50. The method according to any one of embodiments 47 to 49, wherein the step of fastening involves piercing at least one fastener through the weather resistant panel to secure the panels into a place.

51. The method according to any one of embodiments 47 to 50, wherein the at least one fastener being selected from nails, staples, screws, and combinations thereof.

52. The method according to any one of embodiments 47 to 51, wherein the edges between the adjacent weather resistant panels are joined using a tape, a coating, or combination thereof.

### EXAMPLES

### Materials And Methods

Dispex CX 4240: solution of an ammonium salt of an acrylic polymer in water.

Acticide MBS 2550: Mixture of 2-methyl-4-Isothiazolin-3-one and 1,2-Benzisothiazolin-3-one.

Foamaster MO 2133: Multi-hydrophobic blend containing silicone and mineral oil.

TiPure R960: Ti-Pure™ R-960 is a rutile titanium dioxide (TiO₂) pigment that provides maximum gloss retention and efficient UV protection.

Minex 10: MINEX® 10 by Sibelco Specialty Minerals is a micronized functional filler and extender. It is produced from nepheline syenite which is a naturally occurring, silica deficient, sodium-potassium alumina silicate.

Minex 4: MINEX® 4 is a micronized functional filler and/or extender produced from nepheline syenite: a naturally occurring, silica deficient, sodium-potassium alumina silicate.

Kadox 915/Zoco 101: Non-ferrous zinc oxide/ZOCO 101 is a fine particle size, high purity zinc oxide used for applications that require higher reactivity and additional suspension.

Natrosol 250 MBR: Natrosol™ 250 MBR by Ashland is a water-soluble hydroxyethylcellulose surface-treated with glyoxal. It functions as a high efficiency non-ionic thickener, water retention aid and rheology modifier in all types of water-based paints and surface coatings.

Acronal 4511: Aqueous acrylate-acrylonitrile copolymer dispersion for the manufacture of adhesives and elastomeric coatings. Aqueous acrylate-acrylonitrile are copolymers with:
a) 45-90 parts butylacrylate (BA),
b) 0-35 parts methylmethacrylate (MMA),
c) 0-20 parts 2-ethylhexyl acrylate (2-EHA),
d) 0-10 parts Acrylonitrile,
e) 1-3 parts Methacrylic acid, and
f) 0.5-3 parts Acrylamide or derivative thereof.

Acronal NX 3587: Aqueous acrylate-acrylonitrile copolymer dispersion for the manufacture of adhesives and elastomeric coatings. Aqueous acrylate-acrylonitrile are copolymers with:
a) 45-90 parts butylacrylate (BA),
b) 0-35 parts methylmethacrylate (MMA)
c) 0-20 parts 2-ethylhexyl acrylate (2-EHA)
d) 0-10 parts Acrylonitrile
e) 1-3 parts Methacrylic acid
f) 0.5-3 parts Acrylamide or derivative thereof

Acticide MKW2: ACTICIDE® MKW 1 by Thor is an industrial microbiocide. It is a mixture of diuron [3-(3,4-dichlorophenyl)-1,1-dimethylurea] (15%), 3-iodo-2-propynyl butylcarbamate (10%) and 2-N-Octyl-4-isothiazolin-3-one (7.5%). It controls the growth of bacteria and fungi.

Acticide MKW2: ACTICIDE® MKW 1 is applicable in building materials such as sealants, mastics and caulks.

Rheovis PE 1331 (DSX 3121): polyether solution in water.

TABLE 1
Heat curable basecoat composition C17-118B
Heat curable basecoat composition: C17-118B

| | Weight, | Weight, | | |
|---|---|---|---|---|
| | lbs | grams | Gallons | ml |
| Premix the starch solution | | | | |
| D.I. Water - Cold | 21.10 | 9570.8 | 2.53 | 9577 |
| Bentonite Clay | 0.03 | 13.6 | 0.00 | |
| Resizta Starch | 17.05 | 7733.7 | 1.36 | 5148 |
| Acticide MBS 2550 (Biocide) | 0.02 | 9.1 | 0.00 | |
| Grind | | | | |
| Acronal 4511 | 91.17 | 41354.0 | 10.50 | 39747 |
| D.I. Water | 60.78 | 27569.3 | 7.30 | 27633 |
| Dispex CX 4240 | 7.76 | 3519.9 | 0.78 | 2592 |
| Foamaster ST 2446 | 4.92 | 2231.7 | 0.59 | 2233 |
| TiPure R960 (Titanium Dioxide) | 46.59 | 21132.9 | 1.44 | 5451 |
| Minex 10 | 93.17 | 42261.2 | 4.15 | 15709 |
| Minex 4 | 69.88 | 31697.0 | 3.09 | 11697 |
| Zoco 101 | 11.65 | 5284.3 | 0.25 | 946 |
| Letdown | | | | |
| Acronal 4511 | 545.52 | 247443.7 | 62.84 | 237875 |
| Acticide MBS 2550 (Biocide) | 3.11 | 1410.6 | 0.35 | 1325 |
| Acticide MKW2 | 9.32 | 4227.5 | 1.01 | 3823 |
| Foamaster ST 2446 | 4.92 | 2231.7 | 0.59 | 2233 |
| Rheovis PE 1331 | 27.49 | 12469.2 | 3.20 | 12113 |
| Add Starch Solution | | | | |
| Formulation Total | 1014.48 | 460160.4 | 100.00 | 378541 |

TABLE 2
Physical constants for heat curable basecoat composition C17-118B
Physical constants for heat curable basecoat composition: C17-118B

| Solids Content | |
|---|---|
| by Weight | 63.19% |
| by Volume | 56.69% |
| Viscosity (KU) | 102 (or 1713 cps) |
| PVC | 18.97% |
| pH | 8-8.5 |

TABLE 3
Heat curable topcoat composition C17-118A
Heat curable topcoat composition: C17-118A

| | Weight, | Weight, | | |
|---|---|---|---|---|
| | lbs | grams | Gallons | ml |
| Premix the starch solution | | | | |
| D.I. Water - Cold | 15.16 | 6876 | 1.82 | 6889 |
| Bentonite Clay | 0.03 | 14 | 0.00 | |
| Resizta Starch | 12.24 | 5552 | 0.98 | 3709 |
| Acticide MBS 2550 (Biocide) | 1.03 | 467 | 0.12 | 454 |
| Grind | | | | |
| Acronal NX 3587 | 214.68 | 97377 | 24.98 | 94560 |
| Water | 131.20 | 59511 | 15.75 | 59620 |
| Dispex AA 4144 | 17.04 | 7729 | 1.67 | 6321 |
| Foamaster ST 2446 | 5.56 | 2522 | 0.67 | 2536 |
| TiPure R960 (Titanium Dioxide) | 117.53 | 53311 | 3.64 | 13779 |
| Minex 10 | 248.71 | 112813 | 11.08 | 41942 |
| Minex 4 | 176.30 | 79968 | 7.80 | 29526 |
| Letdown | | | | |
| Acronal NX 3587 | 242.43 | 109964 | 28.20 | 106748 |
| Acticide MBS 2550 (Biocide) | 2.04 | 9253 | 0.23 | 870 |
| Acticide MKW2 | 6.13 | 2780 | 0.67 | 2536 |
| Foamaster ST 2446 | 5.56 | 2522 | 0.67 | 2536 |
| Rheovis PE 1331 | 14.80 | 6713 | 1.72 | 6511 |
| Add Premixed Starch Solution | | | | |
| Formulation Total | 1210.45 | 549051 | 100.00 | 378541 |

TABLE 4
Physical constants for heat curable topcoat composition C17-118A
Physical constants for heat curable topcoat composition: C17-118A

| Solids Content | |
|---|---|
| by Weight | 70.24% |
| by Volume | 57.80% |
| Viscosity (KU) | 97 (or 1443 cps) |
| PVC | 42.42% |
| pH | 8.5 |

### Example 1: Experimental Procedure for Preparing a Coated Panel Using the Heat Curable Basecoat Composition-C17-118B and Heat Curable Topcoat Composition-C17-118A

A moisture resistant eXP exterior panel (board) having at least one surface was used as basestock and its surface to be coated was heated to a temperature of 46° C. A heat curable basecoat composition-C17-118B (First coating composition) was applied in an amount of 102.3 g/m². The basecoat composition-C17-118B was dried at a temperature of 82° C. to obtain a first coating on the panel. A heat curable topcoat composition-C17-118A (Second coating composition) was applied on the surface of the dried first coating in an amount of 118.4 g/m². The heat curable topcoat composition-C17-118A was dried at a temperature of 99° C. to obtain a second coating on the panel. The combination of first and second coating provides a weather resistant coating on the panel.

Nail Sealability in Accordance with ASTM D1970

In the present invention, nail sealability tests for heat cured coatings on weather resistant panel obtained by Example 1 were performed in accordance with ASTM D1970.

Accordingly, heat cured coating of panel of Example 1 passed the nail sealability test.

Weather resistant panels were also prepared using following UV curable compositions.

TABLE 5
UV curable basecoat composition C16-166A
UV curable basecoat composition: C16-166A

| | Weight, | Weight, | | |
|---|---|---|---|---|
| | lbs | grams | Gallons | ml |
| Premix - Mix the following for | | | | |
| 10 mins | | | | |
| Water | 140.94 | 63929 | 16.92 | 64049 |
| Propylene Glycol | 21.60 | 9797 | 2.51 | 9501 |
| Natrosol 250 MBR (Premix w/ | 4.32 | 1959 | 0.38 | 1438 |
| Water) | | | | |
| Grind Stage - Add and grind for | | | | |
| 15 mins at high speed | | | | |
| Dispex CX 4240 | 7.20 | 3266 | 0.72 | 2725 |
| Acticide MBS 2550 (Biocide) | 2.88 | 1306 | 0.33 | 1249 |
| Foamaster MO 2133 | 4.32 | 1959 | 0.61 | 2309 |
| TiPure R960 (Titanium Dioxide) | 43.20 | 19595 | 1.34 | 5072 |
| Minex 10 | 86.40 | 39190 | 3.85 | 14574 |
| Minex 4 | 64.80 | 29393 | 2.87 | 10864 |
| Kadox 915 | 10.80 | 4899 | 0.23 | 871 |
| Add following in grind and mix | | | | |
| for 5 mins at low speed | | | | |
| Foamaster MO 2133 | 4.32 | 1959 | 0.61 | 2309 |
| Thindown - Add and mix for 10 | | | | |
| mins | | | | |
| Acronal 4511 | 590.40 | 267801 | 68.01 | 257446 |
| Acticide MKW2 | 8.64 | 3919 | 0.94 | 3558 |
| Rheovis PE 1331 | 4.32 | 1959 | 0.50 | 1892 |
| Foamaster MO 2133 | 1.44 | 653 | 0.20 | 757 |
| Formulation Total | 995.58 | 451587 | 100.01 | 378579 |

TABLE 6
Physical constants for UV curable basecoat composition C16-166A
Physical Constants for UV curable Basecoat C16-166A

| Solids Content | |
|---|---|
| by Weight | 58.20% |
| by Volume | 51.48% |
| Viscosity (KU) | 118 (or 2702 cps) |
| PVC | 17.8% |
| pH | 7.17 |

TABLE 7
UV curable topcoat composition 16-60C
UV curable topcoat composition 16-60C

| | Weight, | Weight, | | |
|---|---|---|---|---|
| | lbs | grams | Gallons | ml |
| Pigment grind | | | | |
| Water | 151.56 | 68746 | 18.19 | 68856 |
| Propylene Glycol | 15.14 | 6867 | 1.76 | 6662 |
| Dispex CX 4240 | 5.05 | 2291 | 0.50 | 1892 |
| Acticide MBS 2550 (Biocide) | 2.00 | 9072 | 0.23 | 871 |
| Foamaster MO 2133 | 3.05 | 1383 | 0.43 | 1628 |
| TiPure R960 (Titanium Dioxide) | 101.08 | 45849 | 3.13 | 11848 |
| Minex 10 | 202.16 | 91698 | 9.01 | 34106 |
| Minex 4 | 151.56 | 68746 | 6.71 | 25400 |
| Zoco 101 | 25.24 | 11585 | 0.54 | 2044 |
| Foamaster MO 2133 | 3.05 | 1383 | 0.43 | 1628 |
| Premix the following | | | | |
| Natrosol 250 MBR (Premix w/ | 6.10 | 2767 | 0.53 | 2006 |
| Water) | | | | |
| Water (Premix with Natrosol) | 83.00 | 37648 | 9.63 | 36453 |
| Letdown | | | | |
| Acronal 4511 | 414.42 | 187978 | 47.74 | 180715 |
| Acticide MKW2 | 6.10 | 2767 | 0.66 | 2498 |
| Rheovis PE 1331 | 3.05 | 1383 | 0.36 | 1362 |
| Foamaster MO 2133 | 1.06 | | 0.15 | 568 |
| Formulation Total | 1173.65 | 532358 | 100.00 | 378541 |

TABLE 8
Physical constants for UV curable topcoat composition C16-60C
Physical Constants for UV curable Topcoat composition 16-60C

| Solids Content | |
|---|---|
| by Weight | 63.55% |
| by Volume | 49.99% |
| PVC | 42% |
| Viscosity (KU) | 102 (or 1713 cps) |
| pH | 8.5 |

TABLE 9
UV curable topcoat/basecoat composition C16-130C
UV curable topcoat/basecoat composition: C16-130C

| | C (Weights, | C (Weights, |
|---|---|---|
| Ingredient | lbs) | grams) |
| Pigment grind, 20 mins | | |
| Water | 225.00 | 102058 |
| Propylene Glycol | 22.50 | 10206 |
| Dispex CX 4240 | 7.50 | 3402 |
| Acticide MBS 2550 | 3.00 | 1360 |
| Foamaster MO 2133 | 4.50 | 2041 |
| TiPure R960 | 45.00 | 20411 |
| Minex 10 | 90.00 | 40823 |
| Minex 4 | 67.50 | 438850 |
| Kadox 915 | 11.25 | 5103 |
| Foamaster MO 2133 (Foamaster SA 3) | 4.50 | 2041 |
| Premix the following | | |
| Natrosol 250 MBR | 4.50 | 2041 |
| Water | 125.40 | 56880 |
| Total | 610.65 | |
| Acronal 4511 | 615.00 | 278959 |
| Acticide MKW2 | 9.00 | 4082 |
| Rheovis PE 1331 (DSX 3121) | 4.50 | 2041 |
| Foamaster MO 2133 (Foamaster SA 3) | 1.50 | 680 |
| Total | 1240.65 | 562749 |

TABLE 10
Physical constants for heat curable topcoat/
basecoat composition C16-130C
Physical Constants for UV curable topcoat/
basecoat composition C16-130C

| | |
|---|---|
| PVC | 17.93% |
| Resin Tg (° C.) | −29 |
| Viscosity (KU) | 102.4 (or 1740 cps) |
| Solids % (by weight) | 47.91% |
| pH | 7.91 |

Weather resistant panels (boards) A-F were produced using UV curable compositions, described above in Tables 5-10.

Weather resistant panels were produced by coating UV curable compositions (mentioned above) on a special (moisture resistant) eXP exterior panel (board) used as basestock.

### Example A: Experimental Procedure for Preparing a Coated Panel Using the UV Curable Basecoat Composition-C16-60C and UV Curable Topcoat Composition-C16-60C

Panel A was produced using procedure in Example 1, except that:
the initial temperature of the surface of the panel to be coated was 18° C.;
The first coating composition and second coating compositions were applied in an amount such that the final amount of the first coating to the final amount of the second coating were in a ratio of 50:50 by weight;
After coating the panel surface with UV curable basecoat composition-C16-60C (First coating composition), it was dried at a temperature of 88° C., and then cured by exposing to energy rays of 1.0 mJ/gsm to obtain a first coating on the panel; and
After coating the surface of the First coating with UV curable basecoat composition-C16-60C (Second coating composition), it was dried at a temperature of 99° C., and then cured by exposing to energy rays of 1.0 mJ/gsm to obtain a second coating on the surface of the First coating on panel.

### Example B: Experimental Procedure for Preparing a Coated Panel Using the UV Curable Basecoat Composition-C16130C and UV Curable Topcoat Composition-C16130C

Panel B was produced using procedure in Example A, except that the UV curable basecoat composition-C16130C (first coating composition) and UV curable topcoat composition-C16130C (second coating composition) were applied in an amount such that the ratio of final amounts of the first coating to the final amount of the second coating were in a ratio of 50:50 by weight.

### Example C: Experimental Procedure for Preparing a Coated Panel Using the UV Curable Basecoat Composition-C16130C and UV Curable Topcoat Composition-C1660C

Panel C was produced using procedure in Example A, except that the UV curable basecoat composition-C16130C (first coating composition) and UV curable topcoat composition-C1660C (second coating composition) were applied in an amount such that final amounts of the first coating to the final amount of the second coating were in a ratio of 60:40 by weight.

### Example D: Experimental Procedure for Preparing a Coated Panel Using the UV Curable Basecoat Composition-C16130C and UV Curable Topcoat Composition-C1660C

Panel D was produced using procedure in Example A, except that the UV curable basecoat composition-C16130C (first coating composition) and UV curable topcoat composition-C1660C (second coating composition) were applied in an amount such that final amounts of the first coating to the final amount of the second coating were in a ratio of 50:50 by weight.

### Example E: Experimental Procedure for Preparing a Coated Panel Using the UV Curable Basecoat Composition-C16166A and UV Curable Topcoat Composition-C1660C

Panel C was produced using procedure in Example A, except that the UV curable basecoat composition-C16166A (first coating composition) and UV curable topcoat composition-C1660C (second coating composition) were applied in an amount such that final amounts of the first coating to the final amount of the second coating were in a ratio of 60:40 by weight.

### Example F: Experimental Procedure for Preparing a Coated Panel Using the UV Curable Basecoat Composition-C16166A and UV Curable Topcoat Composition-C1660C

Panel C was produced using procedure in Example A, except that the UV curable basecoat composition-C16166A (first coating composition) and UV curable topcoat composition-C1660C (second coating composition) were applied in an amount such that final amounts of the first coating to the final amount of the second coating were in a ratio of 50:50 by weight.

The weather resistant coatings on panels A to F were individually tested and characterized for:
medium permeable vapor retarding properties according to International Residential Code (IRC), Class III;
self-healing nail sealability, according to ASTM D1970;
water absorption according to ASTM D471;
water vapour transmission as determined according to ASTM E96;
COBB tests; and
Stackability tests.

The data is summarized in the Table 11 and showed that the coated panels E and F were unique in that they both passed the nail sealability tests.

TABLE 11
Results for panels produced according to Examples A-F

| | | | | | | | |
|---|---|---|---|---|---|---|---|
| Systems | Specification | A | B | C | D | E | F |
| Topcoat | Requirement | C1660C | C16130C | C1660C | C1660C | C1660C | C1660C |
| Topcoat | | 50% | 50% | 40% | 50% | 40% | 50% |
| Weight % | | | | | | | |
| Basecoat | | C1660C | C16130C | C16130C | C16130C | C16166A | C16166A |
| Basecoat | | 50% | 50% | 60% | 50% | 60% | 50% |
| Weight % | | | | | | | |
| E96A | >/=5.0 | 5.7 | 5.0 | Cannot test - topcoat | | 3.5 | 3.5 |
| Hydrostatic | <5.0 g | Pass | N/A | blistered | | Pass | Pass |
| Surface | | Pass | Pass | | | Pass | Pass |
| Burning | | | | | | | |
| Nail | | Fail | Pass | | | Pass | Pass |
| Sealability | | | | | | | |
| Cobb | | 0.80 | N/A | | | 0.34 | 0.33 |
| Stackibility | | Pass | Fail | | | Pass | Pass |
| Z Tensile | | 89.84 | N/A | | | N/A | N/A |
| 2 hrs Water | | 5.70% | N/A | | | 3% | 3% |
| Absorption | | | | | | | |

UV cured coatings of panels C and D could not be tested for Water Vapor Permeability in accordance with ASTM E96, Nail sealability in accordance with ASTM D1970, AATCC 127 Hydrostatic Pressure Test, COBB tests, Stackibility tests, 2 hrs Water Absorption test according to ASTM D471, and other tests as the top coating was blistered during its production.

Water Vapor Permeability in Accordance with ASTM E96

In the present invention, water vapor permeability of UV cured coatings on weather resistant panels A-F were measured in accordance with ASTM E96 at a temperature of 20-24° C.

Accordingly, UV cured coating of panels E and F had a water vapor permeability of 3.5 perm or less, with an average RH of 50 (±3) % (when measured at temperature 20 to 23 C). On the contrary, UV cured coatings of panels A and B had a water vapor permeability of 5 perm or above, with an average RH of 25%.

Nail Sealability in Accordance with ASTM D1970

In the present invention, nail sealability of UV cured coatings on weather resistant panels A-F were measured in accordance with ASTM D1970.

Accordingly, UV cured coating of panels B, E and F passed the nail sealability test. On the contrary, UV cured coating of panel A failed the nail sealability test.

### AATCC 127 Hydrostatic Pressure Test

In the present invention, UV cured coatings on weather resistant panels A-F were subjected to AATCC 127 Hydrostatic Pressure Test to measure the resistance of a coating to the penetration of water under hydrostatic pressure.

Accordingly, UV cured coating of panels A, E and F passed the AATCC 127 Hydrostatic Pressure Test. UV cured coating of panel B could not be used for hydrostatic test.

### COBB Tests

COBB tests are performed on UV cured coatings on weather resistant panels A-F because the panels tend to attract and retain water molecules from the surrounding environment. These tests determine the ability of weather resistant panels to resist water penetration, and the amount of water absorbed. If too much water is absorbed, weather resistant panels A-F with UV cured coatings would have difficulty maintaining strength and integrity.

In the present invention, weather resistant panels A-F with UV cured coatings were subjected to COBB tests to measure the resistance of the UV cured coating to the penetration of water under hydrostatic pressure. Accordingly, UV cured coating of panels E and F passed the COBB Test with a value of 0.34. UV cured coating of panel A passed the COBB test with a value of 0.8.

### 2 Hour Water Absorption Test According to ASTM D471

Swelling of weather resistant panel coated with a UV cured coating is dependent on the ability of the coating to resist water from penetrating into the coating and retained within the coating. Greater water absorption by the coating causes it to swell, thereby leading to change in dimensions of the coating and panel, loss of tensile strength and adhesion, delamination and fracturing of panel, and ending up with further water ingress. Therefore, weather resistant coatings must be resistant to water absorption when continuously submerged in water, for them to satisfactorily perform over a long period of time.

In the present invention, weather resistant panels A-F with UV cured coatings were subjected to water absorption to measure the percentage of water absorbed by the coating and the swell ratio of the UV cured coating. Accordingly. UV cured coating of panels E and F passed the water absorption test with a value of 3%. On the other hand, for the UV cured coating of panel A the water absorption test resulted in a value of 5.7%.

### Stackability Test

At times, coated panels are stacked for long periods of time during storage, transport, and shipment. Thus, the coated panels are exposed to higher pressures, heat, and moisture geographical location and the storage conditions. Therefore, it is critical that the coatings have a good blocking resistance i.e. the ability of a coating to resist sticking to the surface of another coating or resist a change in its appearance due to weight/pressure over long periods of time.

In the present invention, weather resistant panels A-F with UV cured coatings were subjected to stackability test to measure block resistance. Accordingly, UV cured coating of panels A, E and F passed the stackability test.

Thus, weather resistant panels E and F with inventive UV cured coatings, prepared from:
1. UV curable basecoat compositions having a pigment volume concentration (PVC) from 8% to 20%; and 2. UV curable topcoat compositions have a second pigment volume concentration (PVC) from 20% to 52%;
have medium permeable vapor retarding properties according to International Residential Code (IRC), Class III,
have a water vapor permeability of 5.0 perm or less in accordance with ASTM E96 at a temperature of 21° C., with an average RH of 25%,
passed the nail sealability test in accordance with ASTM D1970,
passed the AATCC 127 Hydrostatic Pressure Test,
passed the COBB Test with a value of 0.34,
passed the water absorption test with a value of 3%, and
passed the stackability test.

On the contrary, weather resistant panels A, B, C and D, which were NOT prepared according to following inventive concept:
1. UV curable basecoat compositions having a pigment volume concentration (PVC) from 8% to 20%; and 2. UV curable topcoat compositions having a second pigment volume concentration (PVC) from 20% to 52%;
failed one or more of the above tests or their top coating was blistered during its production.

What is claimed is:

1. A weather resistant panel obtained by:
a) providing at least one panel comprising at least one surface;
b) providing a first coating composition comprising,
i) 34.0 wt. % to 75.0 wt. % of at least one first aqueous acrylate-acrylonitrile copolymer dispersion;
ii) 0.5 wt. % to 9.0 wt. % of at least one first pigment;
iii) 3.0 wt. % to 20.0 wt. % of at least one first filler, at least one first extender, and combinations thereof; and
iv) 0.1 wt. % to 10.0 wt. % of at least one first additive;
wherein the weight percent being relative to the total weight of the first coating composition; and
wherein the first coating composition has a first pigment volume concentration (PVC) from 8% to 20%;
c) applying 50.0 g/m² to 275.0 g/m² of the first coating composition on the at least one surface of the at least one panel;
d) drying the first coating composition on the at least one surface of the at least one panel to obtain a first coating;
e) providing a second coating composition comprising,
i) 20.0 wt. % to 60.0 wt. % of at least one second aqueous acrylate-acrylonitrile copolymer dispersion;
ii) 1.0 wt. % to 7.0 wt. % of at least one second pigment; and
iii) 5.0 wt. % to 25.0 wt. % of at least one second filler and at least one second extender, and combinations thereof; and
iv) 0.1 wt. % to 10.0 wt. % of at least one second additive;
wherein the weight percent being relative to the total weight of the second coating composition; and
wherein the second coating composition has a second pigment volume concentration (PVC) from 20% to 52%;
f) applying 50.0 g/m² to 275.0 g/m² of the second coating composition on the dried first coating; and
g) drying the second coating composition on the dried first coating to obtain a second coating,
wherein the first coating being adjacent to the at least one surface of the at least one panel, and the second coating being adjacent to the first coating;
wherein the combination of the first coating and the second coating forms a weather resistant coating on the at least one panel; and
wherein the weather resistant coating being characterized by:
i) medium permeable vapor retarding properties according to International Residential Code (IRC), Class III, permeable air barrier;
ii) self-healing nail sealability, according to ASTM D1970;
iii) water absorption from 0 to 10 according to ASTM D471; and
iv) water vapour transmission rate from 0.1 to 10.0 perms as determined according to ASTM E96.

2. The weather resistant panel according to claim 1, wherein in step (a), the at least one panel being selected from wooden panel, gypsum board, plywood, sheathing panel, oriented strand board (OSB), drywall panels or combinations thereof.

3. The weather resistant panel according to claim 1, wherein in step (b), the at least one first aqueous acrylate-acrylonitrile copolymer comprising at least one first acrylate and at least one first acrylonitrile; wherein the first aqueous acrylate-acrylonitrile copolymer comprising the first acrylate from 90.0 wt. % to 99.95 wt. %, and the first acrylonitrile from 0.05 wt. % to 10.0 wt. %.

4. The weather resistant panel according to claim 1, wherein in step (b), the at least one first pigment being inorganic pigment selected from rutile titanium dioxide (TiO₂), Carbon Black, Micronized precipitated silica, Talc, and combinations thereof.

5. The weather resistant panel according to claim 1, wherein in step (b), the at least one first filler being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof, and wherein the at least one first extender being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof.

6. The weather resistant panel according to claim 1, wherein in step (b), the at least one first additive being a first drying agent is starch, or a first photoinitiator selected from benzophenone, alpha hydroxy ketone, acryl phosphone oxide and combinations thereof.

7. The weather resistant panel according to claim 1, wherein step (c) involves applying the first coating composition over a time period from 10 to 60 seconds at a temperature from 15° C., to 87° C.

8. The weather resistant panel according to claim 1, wherein step (d) involves drying the first coating composition applied on the at least one surface of the at least one panel, over a time period from 10 to 60 seconds at a temperature from 87° C. to 235° C.

9. The weather resistant panel according to claim 1, wherein the first coating composition further comprising at least one first defoamer, first rheology modifier, first dispersing agent and combinations thereof.

10. The weather resistant panel according to claim 1, wherein in step (e), the at least one second aqueous acrylate-acrylonitrile copolymer comprising at least one second acrylate and at least one second acrylonitrile: wherein the second aqueous acrylate-acrylonitrile copolymer comprising the second acrylate from 90.0 wt. % to 99.5 wt. %, and the second acrylonitrile from 0.05 wt. % to 10 wt. %.

11. The method according to claim 1, wherein in step (e), the at least one second aqueous acrylate-acrylonitrile copolymer dispersion comprising from 30 to 75% solids.

12. The method according to claim 1, wherein in step (e), the at least one second aqueous acrylate-acrylonitrile copolymer dispersion having a glass transition temperature from −25° C. to −35° C.

13. The weather resistant panel according to claim 1, wherein in step (e), the at least one second pigment being inorganic pigment selected from rutile titanium dioxide (TiO₂), Carbon Black, Micronized precipitated silica, Talc, and combinations thereof.

14. The weather resistant panel according to claim 1, wherein in step (e), the at least one second filler being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based and combinations thereof, and wherein the at least one second extender being selected from sodium-potassium alumina silicate, zinc oxide, clay, starch, chalk (calcium carbonate), fibers, carbon black, titanium dioxide, solid or hollow glass beads, microbeads of other materials, silica, silicates, gypsum, antimony oxide, aluminum trihydrate, Barite, Wollastonite (CaSiO₃), mica, talc, pyrophyllite, quartz, organic based, and combinations thereof.

15. The weather resistant panel according to claim 1, wherein in step (e), the at least one second additive being a second drying agent is starch, or a second photoinitiator selected from benzophenone, alpha hydroxy ketone, acryl phosphone oxide and combinations thereof.

16. The weather resistant panel according to claim 1, wherein step (f) involves applying the second coating composition over a time period from 15 to 60 seconds at a temperature from 18° C., to 120° C.

17. The weather resistant panel according to claim 1, wherein step (g) involves drying the second coating composition applied on the at least one surface of the first coating on the at least one panel, over a time period from 10 to 60 seconds at a temperature from 87° C., to 235° C.

18. The weather resistant panel according to claim 1, further comprising at least one second defoamer, second rheology modifier, second dispersing agent and combinations thereof.

19. A method for preparing a weather resistant panel system, the method comprising:
a) providing at least two weather resistant panels according to claim 1;
b) positioning the at least two weather resistant panels adjacently into a desired position against a structure; and
c) fastening the adjacently positioned weather resistant panels against the structure to obtain the weather resistant panel system.
